(19) United States
(12) Patent Application Publication
(10) Pub. No.: US 2013/0309585 A1
(43) Pub. Date: Nov. 21, 2013

(54) Ion Exchanger for Processing a Liquid Fluid

(71) Applicant: Mann+ Hummel GMBH, Ludwigsburg (DE)

(72) Inventors: Markus Beylich, Ludwigsburg (DE); Michael Fasold, Auenwald (DE); Jawad Nouri, Marbach (DE)

(73) Assignee: Mann+ Hummel GMBH, Ludwigsburg (DE)

(21) Appl. No.: 13/947,075

(22) Filed: Jul. 21, 2013

Related U.S. Application Data
(63) Continuation of application No. PCT/EP2012/051548, filed on Jan. 31, 2012.

(30) Foreign Application Priority Data
Jan. 31, 2011 (DE) 10 2011 009 923.9

(51) Int. Cl. H01M 8/04

(52) U.S. Cl. CPC H01M 8/04044
USPC 429/410

(57) ABSTRACT

An ion exchanger for processing a liquid fluid of a functional system, in particular a cooling fluid of a cooling device, in particular of a fuel cell system is disclosed. The ion exchanger includes an ion exchanger tank (30) having an inlet (38) for fluid to be processed and an outlet (40) for processed fluid. A granular ion exchange medium (32) is arranged between the inlet (38) and the outlet (40) with respect to the flow. A flexible bag (30) has a meandering flow passage (78) for the fluid. The passage (78) connects the inlet (38) to the outlet (40). The ion exchange medium (32) is located in the passage (78).

### CROSS-REFERENCE TO RELATED APPLICATIONS

This application is U.S. bypass continuation of international patent application no. PCT/EP2012/051548, filed Jan. 31, 2012 designating the United States of America, the entire disclosure of which is incorporated herein by reference. PCT/EP2012/051548 claims priority to German patent application no. 10 2011 009 923.9, filed Jan. 31, 2011.

### TECHNICAL FIELD

The invention concerns an ion exchanger for processing a liquid fluid of a functional system, in particular a cooling fluid of a cooling device, in particular of a fuel cell system, in particular of a motor vehicle, comprising an ion exchange container with an inlet for fluid to be processed and an outlet for processed fluid and in which a granular ion exchange medium is arranged in the flow between the inlet and the outlet.

### BACKGROUND

EP 1 736 242 A2 discloses an ion exchange container for use in a motor vehicle with which a water proportion in an aqueous urea solution which is injected for oxygen reduction of nitrogen oxides into the exhaust gas flow is subjected to decalcification. The ion exchange container has a housing for receiving an ion exchange medium. The aqueous urea solution is supplied by a supply line to the ion exchange container and after having passed through the ion exchange medium is discharged again by means of a discharge line. The ion exchange container comprises two nested housings wherein the inner housing received the ion exchange medium. The urea solution flows through an opening located in the bottom of the inner housing into the interior of the inner housing. It flows through the interior as well as through the ion exchange medium contained therein from bottom to top end is discharged by means of a central discharge socket in a lid area of the inner housing into the discharge line. In order to utilize the ion exchange medium across the entire cross-section of the inner housing, the inlet and the outlet are arranged on opposite sides of the inner housing. This arrangement must be taken into consideration when selecting the mounting space for the ion exchanger, in particular in a motor vehicle. The length of the ion exchange medium that is passed by the liquid fluid for processing is limited by the spacing between the inlet and the outlet.

The invention has the object to design an ion exchanger of the aforementioned kind with which reliably and efficiently liquid fluid can be processed, that is adaptable easily and adaptable to different mounting spaces and/or fields of application,

### SUMMARY OF THE INVENTION

This object is solved according to the invention in that a flexible bag has a meandering passage for the fluid that connects the inlet with the outlet and in which the ion exchange medium is located.

According to the invention, the ion exchange medium is thus arranged in a flexible bag which can be matched simply with respect to its shape and/or size to the existing mounting space. In the bag, a meandering passage for the fluid is realized which determines the flow path for the fluid. The length of the passage through which the fluid must flow is predetermined simply by the number of meanders. By extending the flow path, the exchanger capacity of the ion exchanger is increased. The length of the flow path is not limited by the spacing between the inlet and the outlet. The length of the passage to be flowed through in relation to its cross-section is greater than in case of the ion exchanger known in the prior art. The formation of preferred flow paths in the ion exchange medium by the fluid flowing through is thus reduced. Since the cross-section of the passage in relation to its length can be reduced in comparison to the ion exchanger known in the prior art, it is not required to provide measures for distributing the fluid to be processed across the cross-section. With an appropriate guiding of the passage, the positions of the inlet and the outlet on the bag can be more freely selected than is possible in the ion exchanger of the prior art. Moreover, the meandering course of the passage counteracts formation of preferred flow passages in the ion exchange medium. The flexible bag moreover can be filled in a simple way with the ion exchange medium which reduces the manufacturing expenditure.

The meandering passage can have passage sections that are extending parallel to each other and adjoin each other.

In an advantageous embodiment, the bag can be rolled up to an approximately cylindrical body. The bag can thus be designed to be very compact. In this way, the space requirement for the bag can be further optimized. By the rolling process, the ion exchange medium can be densely packed; this counteracts the formation of preferred flow passages in the ion exchange medium by the fluid passing through in operation of the ion exchanger.

Advantageously, together with the bag a flat flexible protective material, in particular an elastic nonwoven, can be rolled up. The protective material serves as an additional protective layer so that the outer surfaces of the bag are not resting directly on each other. In this way, it is prevented that the outer surfaces of the bag, in particular in case of vibrations, will rub on each other and can be worn through.

Moreover, advantageously the rolled-up bag can be packed into an elastic support sleeve, in particular a compression sleeve. By means of the support sleeve, the ion exchange medium can be held in position in order to prevent that it will be displaced within the bag in particular as a result of the force of gravity and/or as a result of vibrations. Moreover, by means of the support sleeve the ion exchange medium can be compacted. In particular, voids between the ion exchange medium and the inner sides of the bag can be reduced so that the ion exchange medium is resting directly on the inner sides. As a whole, the support sleeve counteracts the formation of preferred flow passages within the ion exchange medium. The bag that is rolled up to a cylindrical body can be introduced easily into the elastic support sleeve. The support sleeve can be an elastic fabric or can be a non-woven material. They support sleeve can be embodied to be net-like or grid-like.

In a further advantageous embodiment, the bag can be made of plastic material and the passage can be delimited by a plurality of in particular parallel connecting curves, in particular weld seams, along which two opposite inner sides of the bag are connected to each other and that alternatingly extend from a first edge of the bag to a spacing, which in particular corresponds to the width of the passage between neighboring connecting curves, relative to an oppositely positioned second edge and from the second edge to a spacing, in particular the same spacing, relative to the first edge. In this way, in a simple and space-saving way a preferably uniform flow passage can be realized. Plastic material can be easily processed, in particular welded, glued, or shaped. Metal parts are not required at all. Therefore, no metal ions can thus be introduced into the fluid. The elimination of metal has a positive effect with regard to future recycling or disposal of the ion exchanger. Connectors for the inlet and the outlet can be simply particularly welded or glued onto the plastic bag. Also, they can be connected monolithically with the bag. Retaining devices, in particular filters or screens, can be provided with which it is prevented that the ion exchange medium can escape through the inlet and/or the outlet from the bag. The retaining devices can be integrated simply into the inlet and/or the outlet. The plastic bag can be produced in a simple way in particular from an endless plastic hose. In the manufacturing process, the plastic hose can be closed off at one end and can be provided with weld seams along the connecting curves. The open end of the plastic hose can be acting as a kind of funnel through which the ion exchange medium can be filled into the bag. After the filling process, the bag can be closed at the open side. The funnel can then be cut off.

Advantageously, the inlet and outlet can be located in the vicinity of the same edge of the bag. In this way, the inlet and the outlet can be arranged in a space-saving way adjacent to each other. Thus, the ion exchanger can be matched in a simple and space-saving way to different functional system, in particular a cooling line of a cooling device. In particular, the inlet and the outlet can be arranged on the bag such that they are located on the same end face of the bag after rolling up.

According to a further advantageous embodiment, the bag can be arranged in a preferably rigid protective housing which is in particular comprised of two half shells. In the protective housing, the rolled-up bag is protected from environmental effects, in particular mechanical loads, temperature effects, dirt and/or chemical substances. The protective housing can protect the bag from destruction when overpressure occurs. The bag can simply be inserted between the two half shells which are subsequently connected fixedly to each other. The protective housing, instead of being comprised of two half shells, can also be comprised of housing members that are closable in a different way.

Advantageously, voids between the protective housing and the bag can be filled with a preferably incompressible filling medium, in particular liquid or foamed material. By filling the voids, the compression resistance in particular of the bag in particular relative to overpressure is further improved. For filling in the filling material, at least one separate fill opening can be provided in the protective housing through which after assembly of the protective housing, the filling medium is filled in and which subsequently can be closed off. By filling the voids between the bag and the protective housing, the bag can be positionally fixed in the protective housing. In this way, in particular wearing through of the bag by rubbing at the protective housing and/or of bag surfaces that are resting on each other can be prevented.

Moreover, advantageously between the bag and the protective housing a rubbing protection, in particular of a thermoplastic material, preferably polyethylene or polyurethane, can be arranged. Between the rolled-up bag and the protective housing a void can be provided in which the rubbing protection is provided. With the rubbing protection, in particular adhesive or weld seams of the bag which otherwise are resting immediately on the protective housing are protected from wearing through by rubbing, in particular as a result of vibrations.

In other respects, advantageously the bag can be attached by means of a strain relief device at a connecting section of the protective housing. In the connecting section, hose connectors for a supply line and discharge line for the fluid can be provided which are connected to the inlet or the outlet of the bag. For improving the mechanical stability, in particular compression resistance and for maintaining the consistency of the ion exchange medium, the part of the bag in which the inlet and the outlet are located can be connected by a potting compound with the connecting section.

### BRIEF DESCRIPTION OF THE DRAWINGS

Further advantages, features and details of the invention may result from the following description in which embodiments of the invention will be explained in more detail with the aid of the drawing. A person skilled in the art will consider the features disclosed in combination in the drawing, the description, and the claims expediently also individually and combine them to additional meaningful combinations. It is shown schematically in:

FIG. 1 an exploded illustration of some components of an ion exchanger for a cooling fluid of a cooling device of a fuel cell system in which a bag with a granular ion exchange material is wound to a cylinder;

FIG. 2 the bag of the ion exchanger of FIG. 1 in the unrolled state;

FIG. 3 the bag of FIGS. 1 and 2 during a manufacturing phase;

FIG. 4 a partial section of the assembled ion exchanger of FIG. 1 in which the bag of the FIGS. 1 to 3 is provided with hose connectors and with strain relief devices with a connecting section of a housing of the ion exchanger;

FIG. 5 schematically a detail view of a hose connector of FIG. 4.

In the Figures, same components are identified with same reference characters.

### DETAILED DESCRIPTION

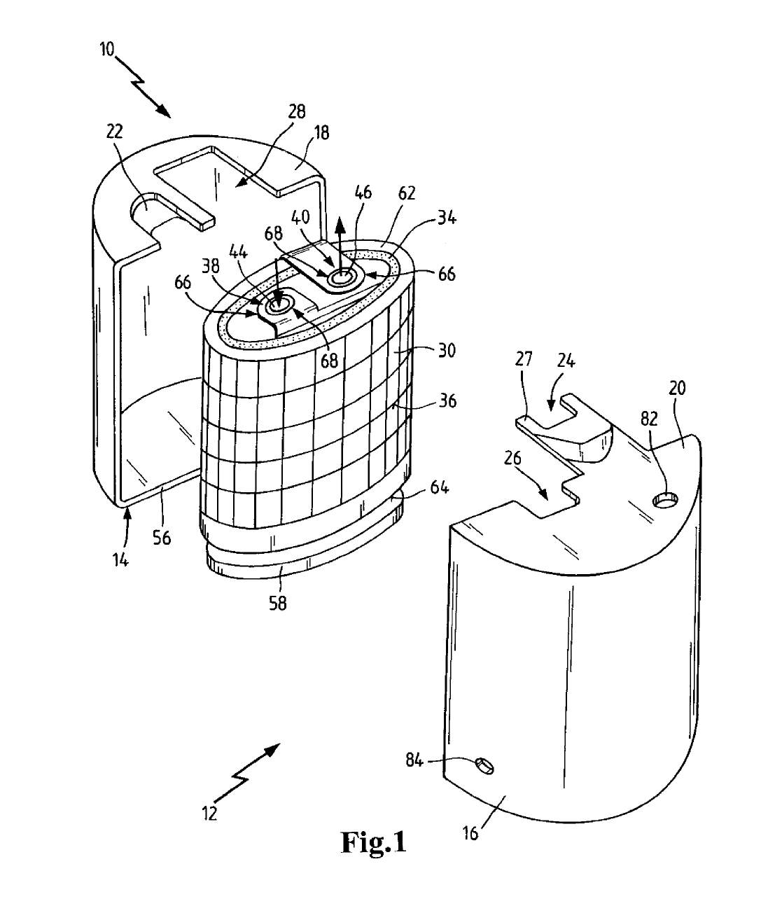

In FIG. 1, an exploded illustration some components of an ion exchanger 10 for processing a cooling fluid of a cooling device, otherwise not shown, of a fuel cell system of a motor vehicle is shown.

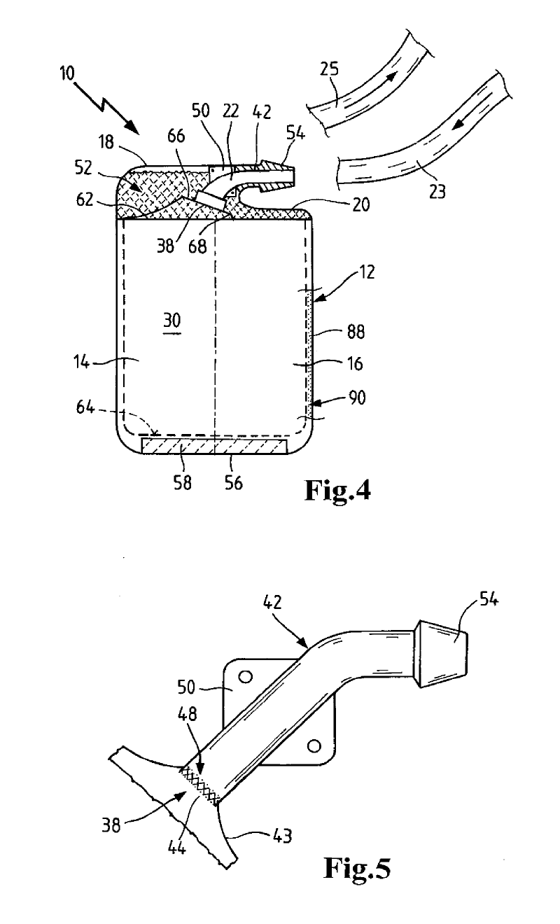

The ion exchanger 10 comprises a protective housing 12 of a rigid plastic material which is comprised of two half shells 14 and 16. When assembled, the protective housing 12, as shown in FIG. 4, has a cylindrical shape.

A connecting section 18 of the half shell 14, rearward in FIG. 1, has in FIG. 1 at the top a supply connector passage 22 for a hose connector 44, shown in FIGS. 4 and 5, for a supply line 23 shown therein for cooling fluid to be processed. A discharge connector passage 24 for a hose connector 42 of a discharge line 25 for the processed cooling fluid is arranged in a connecting section 20 of the half shell 16.

The supply connector passage 22 is laterally open relative to the edge of the half shell 14 which, in the mounted state, is connected with the half shell 16. In the connecting section 20 in the half shell 16, a recess 26 is provided which is aligned with the open side of the supply connector passage 22.

An area 27 of the connector section 20 with the discharge connector passage 24 projects past the edge of the half shell 16 facing the half shell 14. In the connecting section 18 of the rearward half shell 14 a second recess 28 is provided which is complementary to the projecting area 27. In the mounted state, the area 27 engages the second recess 28. In this way, a meshing action is realized which stabilizes the protective housing 12 in the mounted state. In addition, the meshing action serves as a guide for mounting.

The discharge connector passage 24 is also open at the side that is facing the half shell 14. Since the discharge connector passage 24 and the supply connector passage 22 are laterally open, the hose connectors 42 can be simply inserted from the side.

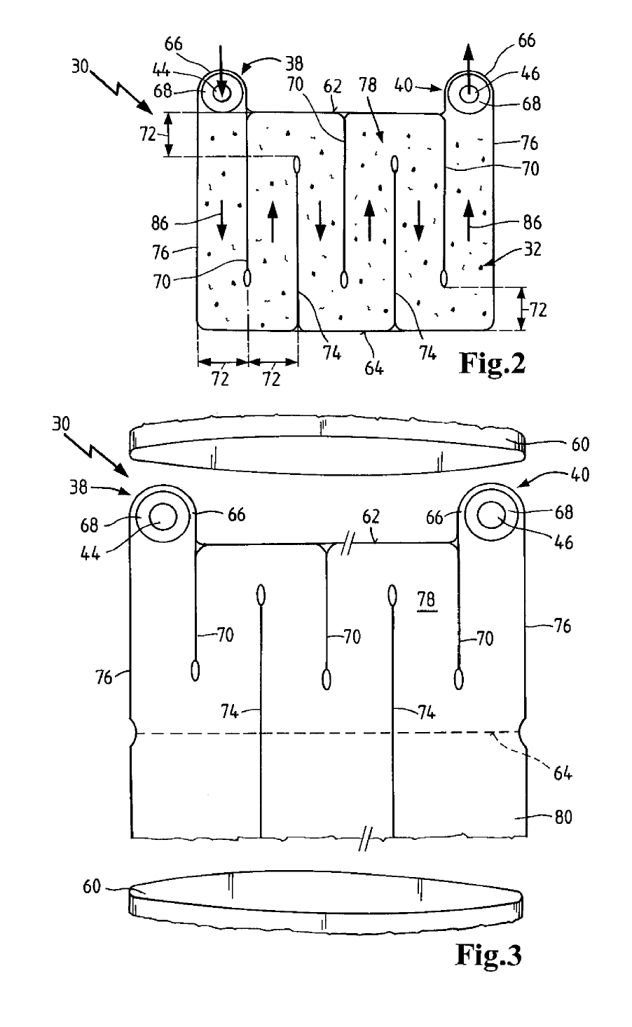

In the protective housing 12, a flexible bag 30 of an elastic plastic film is arranged in which an ion exchange material 32 is located. The function of the granular ion exchange material 32 is sufficiently known. The granular ion exchange material 32 is indicated in FIG. 2. The bag 38 is shown therein in the unrolled state.

The bag 30 is rolled up to a cylindrical body that is shown in FIG. 1. With the bag 30, a flat flexible protective material in the form of a nonwoven 34 is rolled up which protects the exterior sides of the bag 30 from wear-through by rubbing. The bag 30 rolled up together with the nonwoven 34 is packaged in an elastic protective sleeve 36 of an elastic fabric. The support sleeve 36 which is indicated in FIG. 1 as a kind of net has the function of a compression sleeve. It stabilizes the rolled-up bag 30 in its shape and compresses it and the contained granular ion exchange material 32.

An inlet 38 for the cooling fluid to be processed and an outlet 40 for processed cooling fluid are located at the end face of the rolled-up bag 30 facing the connecting sections 18 and 20 of the protective housing 12. In the mounted state of the ion exchanger 10, the inlet 38 corresponds with the supply connector passage 22 and the outlet 40 corresponds with the discharge connector passage 24.

At the inlet 38 and the outlet 48, a hose connector 42 is provided, respectively. The hose connector 42 of the inlet 38 is illustrated in FIGS. 4 and 5. The hose connectors 42 each have an annular weld disk 43. With the annular weld disk 43 the hose connector 42 is welded to the respective welding surface 68 of the bag 30 that surrounds an inlet opening 44 of the inlet 38 or an outlet opening 46 of the outlet 40. In each hose connector 42 a screen 48 is arranged which prevents that granular ion exchange material 32 escapes through the hose connector 42 from the bag 30.

The hose connectors 42 each have a strain relief device 50 with which they are attached on the connecting section 18 of the half shell 14. The hose connectors 42 and the part of the rolled-up bag 30 that is facing the connecting sections 18 and 20 are moreover embedded by a potting compound 52 in the connecting sections 18 and 20. In this way, the mechanical strength, in particular the compression resistance, of the ion exchanger 10 is increased and the consistency of the granular ion exchange material 32 is maintained.

Each hose connector 42 is configured at its free end as a wedge-shaped tapering quick connector 54 onto which the supply line 23 or the discharge line 25 can be pushed and, for example, secured by means of a hose clamp.

Between a bottom-side end face of the rolled-up bag 30 that is oppositely positioned to the inlet 38 and the outlet 40 and a bottom 56 of the protective housing 12, a protective plate 58 of polyethylene is arranged. By means of the protective plate 58 the weld seams at the end face bottom edge 64 of the bag 38 are protected from being worn through by rubbing, for example, by vibrations.

The bag 30 is manufactured of a flattened 10 plastic hose 60 which is indicated in FIG. 3. The plastic hose 60 is welded at both open ends which, as indicated in FIG. 2, form an end face connecting edge 62 and the end face bottom edge 64 of the bag 30 that, as a whole, is approximately rectangular.

The end face connecting edge 62 is shaped to connecting tabs 66 in the area of the lateral edges 76 of the bag 30. In the connecting tabs 66 the inlet opening 44 and the outlet opening 46 and the respective welding surfaces 68 are provided.

From the connecting edge 62 three continuous weld seams 70 that are parallel to the lateral edges 76 extend in the direction toward the end face bottom edge 64. By means of the weld seams 70 the two oppositely positioned inner sides of the plastic hose 60 are connected to each other. The weld seams 70 end at a spacing 72 relative to the end face bottom edge 64.

From the end face bottom edge 64 two weld seams 74 extend parallel to the weld seams 70 in the direction toward the end face connecting edge 62. They also end at the spacing 72 relative to the end face connecting edge 62. The weld seams 74 are located centrally between two neighboring weld seams 70, respectively.

A spacing between neighboring weld seams 70 and 74 and the spacings between the outer weld seams 70 and lateral edges 76 of the bag 38 correspond to the spacing 72. As a whole, a tortuous channel or meandering flow passage 78 for the cooling fluid is realized that across the entire flow passage length has a uniform width corresponding to the spacing 72. The flow passage 78 connects the inlet 38 with the outlet 40. In the flow passage 78 there is the granular ion exchange material 32.

For producing the bag 30, the plastic hose 60 is pressed flat and is provided with continuous seal-tight weld seams at one open end for forming the end face connecting edge 62 and the connecting tabs 66. The oppositely positioned inner sides of the bag 30 are seal-tightly connected by means of parallel weld seams 70 and 74. The weld seams 74 project past the future end face bottom edge 64 which is indicated in FIG. 3 in dashed lines.

At a spacing to the future end face bottom edge 64, the bag 30 is separated from the plastic hose 60 at the side opposite the end face connecting edge 62. A section between the future end face bottom edge 64 and the open end of the bag 38 serves as a funnel section 80.

Subsequently, the bag 30 is arranged such that the open side of the funnel section 80 is located spatially at the top. The granular ion exchange material 32 is filled into the funnel section 90 until the intermediate spaces between the weld seams 70 and 74 that form the flow passage 78 are filled up to the future end face bottom edge 64 with granular ion exchange material 32.

Subsequently, the bag 30 is seal-tightly welded continuously along the line indicated in dashed lines in FIG. 3. The funnel section 80 is then cut off.

The nonwoven 34 is placed flat across the surface onto the bag 30 and is rolled up together with it to a cylindrical body. Subsequently, the rolled-up bag 30 is inserted into the protective sleeve 36.

The hose connectors 42 are then welded with the annular weld disk in 43 to the welding surface 68 of the inlet 38 and the outlet 40.

The rolled-up bag 30 is placed with interposition of the protective plate 58 into the half shell 14 so that the hose connectors 42 extend through the discharge connector passage 24 and the supply connector passage 22. The strain relief devices 50 of the hose connector 42 are connected to the connecting section 18. The half shell 16 is pushed on and is welded to half shell 16.

By means of a fill opening 82, indicated in FIG. 1, in the half shell 16, curable potting compound is filled into the void between the end face connecting edge 62 of the bag 30 and the connecting section 18 and 20 of the half shells 14 and 16. The fill opening 82 is subsequently closed off.

By means of a second fill opening 84, a curable foam 88 is filled in with which, as indicated in FIG. 2, voids 90 between the protective housing 12 and the rolled-up bag 30 and the voids between the meanders of the bag 30 are filled. The second fill opening 84 is subsequently closed off.

Upon operation of the ion exchanger 10 the cooling fluid to be processed flows from the inlet opening 23 across the inlet-side hose connector 42 into the inlet 38. The cooling fluid flows through the passage 78 in the direction of arrows 86 that are illustrated in FIG. 2. It flows thus through the granular ion exchange material 32 and is processed as is known.

The processed cooling fluid exits the bag 30 through the outlet 40 and flows through the outlet-side hose connector 42 out of the protective housing 12 into the discharge line 25 of the cooling devices.

In all of the described embodiments of an ion exchanger 10 inter alia the following modifications are possible:

The invention is not limited to an ion exchanger 10 of cooling devices of fuel cells of motor vehicles. Instead, it can also be employed in ion exchangers of different functional systems for processing different liquid fluids, for example, in ion exchangers for deionizing water in spark erosion machines, in stationary fuel cell applications, or for processing aqueous urea solution which is injected, for example, for oxygen reduction of nitrogen oxides into the exhaust gas flow of an internal combustion engine. Also, the invention can be used for processing drinking water, cooling water, boiler water, or other types of industrial water.

Instead of being made of an elastic plastic film, the bag 30 can also be made of a non-elastic but flexible plastic film.

The potting compound 52 for embedding the hose connectors 42 in the connecting sections 18 and 20 can also be omitted.

Instead of the quick connectors 54 also other types of hose connectors, for example, screw connectors, can be provided for connecting with the supply line 23 and the discharge line 25.

Instead of the screens 48 also different types of screen or filter means can be provided in order to prevent that granular ion exchange material 32 can escape from the bag 30. The screens 48 can also be arranged on the bag 30 instead of in the hose connectors 42.

The protective plate 58, instead of being made of polyethylene, can also be made of another protective material, preferably a thermoplastic material, for example, polyurethane.

In a simplified embodiment of the ion exchanger 10, the protective nonwoven 34 and/or the protective plate 58 can also be omitted.

The foam fill of the voids 90 between the protective housing 12 and the bag 30 and/or between the meanders of the bag 30 by means of the second fill opening 84 can also be omitted. Instead of the curable foam, a different medium that is incompressible in its final state, for example, a liquid, preferably a mixture of same parts of water and glycol, can be used also.

The meandering flow passage 78 can also be realized by more or fewer than five weld seams 70 and 74.

The weld seams 70 and 74, instead of being in the shape of parallel straight lines, can also be realized in the form of at least partially non-parallel straight lines or curves.

The flow passage 78 instead of across its flow length can also be provided with widened portions and/or narrowed portions.

The inlet 38 and the outlet 40, instead of being located in the vicinity of the end face connecting edge 62, can also be positioned at opposite end face edges or lateral edges or also within the bag surface between the end face edges and the lateral edges.

The elastic support sleeve 36 can also be omitted in a simplified embodiment.

The bag 30, instead of being rolled up to a cylindrical body, can also be formed in a different way, for example, folded.

The protective housing 12, instead of being assembled of two half shells 14 and 16, can also be manufactured of two parts in axial direction, for example, a housing cup and a lid. The protective housing can also be comprised of more than two parts.

The half shells 14 and 16 instead of being welded to each other can also be is connected in different ways, for example, can be glued to each other, screwed, or snap-connected to each other.

Instead of the weld seams 70 and 74 and the weld seams at the end face connecting edge 62 and at the end face bottom edge 64 also different kinds of continuous connections of the inner surfaces of the bag, for example, by gluing, can be provided.

1. Ion exchanger (10) for processing a cooling fluid of a cooling device of a fuel cell system, comprising:
an ion exchange container (30) that has an inlet (38) for fluid to be processed and an outlet (40) for processed fluid and in which a granular ion exchange medium (32) is arranged in the flow between the inlet (38) and the outlet (40);
wherein the ion exchange container is embodied as a flexible bag (30);
wherein the flexible bag (30) comprises a meandering passage (78) for the fluid which connects the inlet (38) with the outlet (40) and in which the ion exchange medium (32) is located.

2. The ion exchanger (10) according to claim 1, wherein
the meandering passage has passage sections that are parallel to each other and adjoin each other.

3. The ion exchanger (10) according to claim 2, wherein the bag (30) is rolled up to an approximately cylindrical body.

4. The ion exchanger (10) according to claim 3, wherein
together with the bag (30) a flat flexible protective nonwoven material (34) is rolled up.

5. The ion exchanger according to claim 3, wherein
the rolled-up bag (30) is enclosed within an elastic support compression sleeve (36).

6. The ion exchanger according to claim 1, wherein
the bag (30) is comprised of plastic material and the passage (78) is delimited by a plurality of parallel connecting curves formed by particular weld seams (68, 70), along which two opposite inner sides of the bag (30) are connected to each other and that alternatingly extend from a first edge (62) of the bag (30) up to a spacing (72), which in particular corresponds to the width of the passage (78) between neighboring connecting curves (68, 70), to an oppositely positioned second edge (64) and from the second edge (64) up to a spacing, in particular the same spacing (72), to the first edge (62).

7. The ion exchanger according to claim 6, wherein
the inlet (38) and outlet (40) are proximaly located in vicinity of the same edge (62) of the bag (30).

8. The ion exchanger according to claim 1, wherein
the bag (30) is arranged within in a preferably rigid protective housing (12) comprised of two half shells (14, 16).

9. The Ion exchanger according to claim 8, wherein
voids (90) arranged between the protective housing (12) and the bag (30) are filled with an incompressible filling medium, the filling medium selected from the group: a liquid medium or a foamed material (88).

10. The ion exchanger according to claim 8, wherein
a rubbing protection (58) of a polyethylene or polyurethane thermoplastic material is arranged between the bag (30) and the protective housing (12).

11. The ion exchanger according to one of the claim 8, wherein
the bag (30) is secured by a strain relief device (50) on a connecting section (18) of the protective housing (12).
